(19) United States
(12) Patent Application Publication
(10) Pub. No.: US 2004/0208182 A1
(43) Pub. Date: Oct. 21, 2004

(54) Format independent consumer IR transceiver

(75) Inventors: Colby Boles, Seattle, WA (US); Jay Senior, Seattle, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation

(21) Appl. No.: 10/414,713

(22) Filed: Apr. 16, 2003

(51) Int. Cl. H04L 12/56

(52) U.S. Cl. 370/395.5

(57) ABSTRACT

A method for interfacing a computer with a consumer device by way of a transceiver is disclosed herein. A first signal from a remote control is received at the transceiver. The first signal is encoded and transmitted to the computer by way of a communications link, where the encoded first signal is processed by the computer. An encoded second signal is received at the transceiver from the computer by way of the communications link. The encoded second signal is decoded and transmitted to the consumer device.

### RELATED APPLICATIONS

This patent application relates to commonly assigned copending U.S. Patent Application No. AA/BBB,CCC, filed Apr. 16, 2003 under attorney docket number MSFT-1517 and entitled “Efficient Infrared Decoding Algorithm for Low-Power Applications.”

### FIELD OF THE INVENTION

The present invention relates to a transceiver for remotely controlling a consumer device. More particularly, the present invention relates to using a transceiver to interface a computer with a consumer device by way of a remote control. Even more particularly, the present invention relates to using an infrared (IR) transceiver to receive a command from a computer and to transmit the command to the consumer device. Even more particularly, the present invention relates to methods and apparatus for determining if an infrared transmitter is functioning properly, a method for using the transceiver to measure an IR signal, a method for protecting the computer from a user error upon leaving a sleep state, an automatic firmware updating method and a method for keeping the transceiver in a safe state during such a firmware update.

### BACKGROUND OF THE INVENTION

Many consumer electronic devices use a remote control to receive input from a user. In some applications, a remote control may also receive information from the device. To transmit and receive information from a device, a remote control and a consumer device typically communicate by way of an infrared (IR) signal. In this way, each function of the consumer device, such as power on/off, play, volume up/down, and the like, may be assigned a particular code that is then modulated with an IR carrier frequency. Unfortunately, each type and/or brand of consumer device typically has a unique set of codes. Therefore, any user desiring to control more than one consumer device with the same remote control must have a remote control that either has all of the necessary code sets stored in memory, or has the ability to learn a device's code set from the device's remote control. In addition, a typical consumer device may only be controlled by a remote control having the proper code set, which in most applications is a single remote control. Therefore, the ability to control a consumer device with any of a plurality of remote controls is conventionally not available.

Remote controls have limited functionality, and conventionally cannot control multiple consumer devices in an intelligent manner. For example, a user desiring to watch a television program having a signal provided by a satellite connection, with the sound from the television directed through stereophonic equipment, would have to control each device using each device's remote control. Even if the user uses a single remote control, the user would have to control and adjust each device individually. Attempts to automate the process thus far have been limited to programming simple macros into the conventional remote control to perform a generally simple function such as to turn on all three devices with one button push. However, this method does not work if one of the devices does not receive the signal from the remote, which may occur if something or someone blocks the IR signal. Also, this method is unsuitable for performing complex tasks, such as turning on the television and adjusting the volume, turning on the satellite controller and making proper adjustments, and turning on the stereo, selecting the proper input selection and adjusting the volume. While a remote control could be built and programmed to perform such complex and variable tasks, the more complex functionality required would likely make the remote control more expensive than the public is generally willing to spend. Computers have been used in conjunction with a remote control, but such methods have many shortcomings.

In light of the shortcomings discussed above, what is needed is an IR transceiver that can interface a computer with a consumer device, thereby enabling the functionality of the computer to control devices controlled by remote controls. Furthermore, what is needed is a method for efficiently learning consumer IR signals. In addition, what is needed is a method for determining whether an IR link is functioning properly. Furthermore, what is needed is a method for detecting and compensating for user error upon a device resuming from a sleep state. What is also needed is a device driver to auto detect a remote sensor firmware version and auto update if necessary. What is also needed is a method for keeping a remote sensor in safe state while updating firmware.

### SUMMARY OF THE INVENTION

In view of the above shortcomings, a method for interfacing a computer with a consumer device by way of a transceiver is disclosed herein. A first signal from a remote control is received at the transceiver. The first signal is encoded and transmitted to the computer by way of a communications link, where the encoded first signal is processed by the computer. An encoded second signal is received at the transceiver from the computer by way of the communications link. The encoded second signal is decoded and transmitted to the consumer device.

Furthermore, the method may also be capable of efficiently learning consumer IR signals. In addition, in one embodiment, the method may determine whether an IR link is functioning properly. Furthermore, an embodiment may detect and compensate for a user error after a device resumes from a sleep state. An embodiment may also auto detect a remote sensor firmware version, and auto update if necessary, by way of a device driver. Furthermore, an embodiment may place a peripheral device in a safe state while updating device firmware.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary embodiments of the invention; however, the invention is not limited to the specific methods and instrumentalities disclosed. In the drawings:

FIG. 1 is a block diagram showing an exemplary computing environment in which aspects of the present invention may be implemented;

FIG. 2 is a block diagram showing an exemplary arrangement of computer and transceiver in accordance with one embodiment of the present invention;

FIG. 3 is a flowchart illustrating a method of processing a remote control command and directing a command to a consumer device in accordance with one embodiment of the present invention;

FIG. 4 is a schematic diagram of an IR emitter detector in accordance with one embodiment of the present invention;

FIG. 5 is a block diagram showing an exemplary arrangement of remote control and transceiver in accordance with one embodiment of the present invention;

FIG. 6 is a diagram illustrating waveforms occurring during a method of decoding an IR signal in accordance with one embodiment of the present invention;

FIG. 7 is a flowchart illustrating a method of decoding and determining the carrier frequency of an IR signal in accordance with one embodiment of the present invention;

FIG. 8 is a flowchart illustrating a method of compensating for user error on resume from a sleep state in accordance with one embodiment of the present invention;

FIG. 9 is a flowchart illustrating a method of detecting an out of date firmware version and updating the firmware version in accordance with one embodiment of the present invention;

FIG. 10 is a block diagram illustrating a placement of a flash protection code in accordance with one embodiment of the present invention;

FIG. 11 is a flowchart illustrating a method of keeping a transceiver in a safe state while updating firmware in accordance with one embodiment of the present invention;

### DETAILED DESCRIPTION OF ILLUSTRATIVE EMBODIMENTS

### Overview

The present invention provides an IR transceiver for receiving IR signals from one or more remote controls, sending an encoded signal to a computer for processing, decoding a return signal from the computer, and transmitting an IR signal to one or more consumer devices. In such a manner, the functionality of a computer may be brought to bear on the IR signals used to control consumer devices. The present invention further provides an IR emitter detector for detecting problems with an IR emitter, so that IR transmission problems may be quickly detected and diagnosed. Furthermore, the present invention provides a method of efficiently and cost-effectively decoding an IR signal using the transceiver. In this way, a transceiver may perform such functions while remaining inexpensive to fabricate and purchase.

The present invention also provides a method of compensating for user error on resume from sleep, where a computer may recognize that a standby signal from a user is likely in error, and may then take an alternate action. The present invention further provides for updating the firmware of an IR transceiver. In one aspect, the present invention determines a firmware version upon a device driver startup, and if the firmware version is not the most recent, the present invention may update the firmware automatically without user involvement. In another aspect, the present invention may, at the start of a firmware upgrade, write a flash protection code to a memory location so that if the upgrade is interrupted the transceiver will be able to recognize that the upgrade is not complete and will retry the upgrade.

### Exemplary Computing Environment

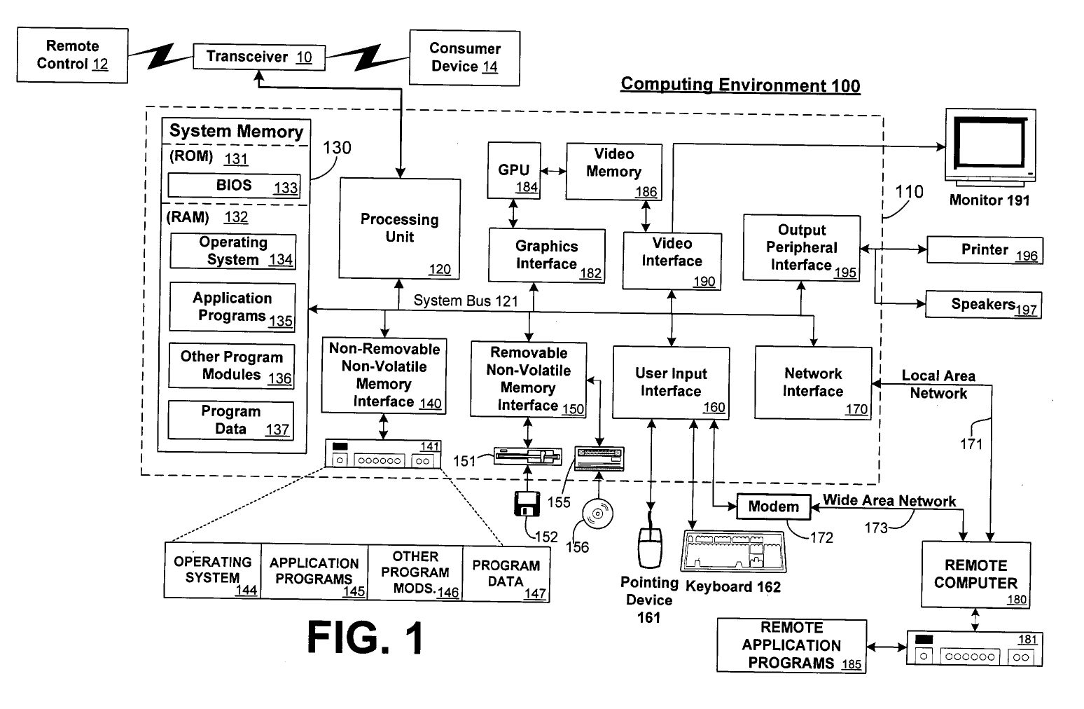

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing the invention includes a general purpose computing device in the form of a computer 10. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 10 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or non-volatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/non-volatile computer storage media. By way of example only, FIG. 1 illustrates a hard disk drive 140 that reads from or writes to non-removable, non-volatile magnetic media, a magnetic disk drive 151 that reads from or writes to a removable, non-volatile magnetic disk 152, and an optical disk drive 155 that reads from or writes to a removable, non-volatile optical disk 156, such as a CD-ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 10, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Exemplary Distributed Computing Frameworks or Architectures

Various distributed computing frameworks have been and are being developed in light of the convergence of personal computing and the Internet. Individuals and business users alike are provided with a seamlessly interoperable and web-enabled interface for applications and computing devices, making computing activities increasingly web browser or network-oriented.

For example, MICROSOFT®'s .NET platform includes servers, building-block services, such as web-based data storage, and downloadable device software. Generally speaking, the.NET platform provides (1) the ability to make the entire range of computing devices work together and to have user information automatically updated and synchronized on all of them, (2) increased interactive capability for web sites, enabled by greater use of XML rather than HTML, (3) online services that feature customized access and delivery of products and services to the user from a central starting point for the management of various applications, such as e-mail, for example, or software, such as Office.NET, (4) centralized data storage, which will increase efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors, and (7) many other cross-platform integration features as well.

While exemplary embodiments herein are described in connection with software residing on a computing device, one or more portions of the invention may also be implemented via an operating system, API, or a “middle man” object between a coprocessor and requesting object, such that services may be performed by, supported in, or accessed via all of.NET's languages and services, and in other distributed computing frameworks as well.

### Exemplary Embodiments

IR Transceiver Peripheral

In addition to the shortcomings of the prior art discussed above, a conventional remote control has several additional shortcomings. For example, some remote controls store all possible consumer device code sets in the remote control; however, such a remote control is limited to the devices for which it has code sets stored in its memory. Adding a capacity to upload additional codes to the remote control, either to add codes for a new device or for an unusual code that was not originally stored on the remote control, may increase the costs of fabricating, and therefore purchasing, the remote control. For example, conventional “learning” remote controls simply record the signal as transmitted by the remote control to be “learned,” and then later transmit the recorded signal as it was recorded. In such a situation, the length of the signal recorded is dependent upon the length of time the button on the learned remote control was pressed by a user. When using time-sensitive functions, such as reverse, fast-forward and even volume up and the like, such a method is inadequate because of the inaccuracies in the length of the resulting transmitted signal. Therefore, a user may fast-forward too far, or not enough, and the overall user experience with the consumer device will be adversely affected.

In addition, and as discussed above, a conventional remote control has limited processing power and functionality, and attempts to increase such functionality typically cause the price of the remote control to increase to an uncompetitively high level. A computer, such as computer 110 or the like, has considerable processing power, but a user computer is typically not located in an advantageous place for controlling IR-controlled consumer devices 14 (FIG. 1). For example, users typically do not place a computer 110 in the middle of a room, where the computer 110 might have a straight line-of-sight IR connection to each consumer device 14 the user wishes to control with the computer 110.

Accordingly, what is needed is an IR transceiver peripheral for a computer that enables the user of a remote control 12 to input a command to the computer 110 and to control an IR enabled consumer device 14 by way of the computer 110. More particularly, what is needed is such an IR transceiver that may have IR-specific functionality on board, and where the remainder of the functionality may be provided by computer 10. As may be appreciated, the IR transceiver may be of an appropriate size to be located where such IR transceiver will have an IR connection to each consumer device 14 to be controlled.

Thus, as can be seen in FIG. 1, an IR transceiver 10 is placed in operative communications with computer 110. In one embodiment, such connection is by way of a USB connection although any type of connection, whether wired or wireless, is consistent with an embodiment of the present invention. Remote control 12 communicates with IR transceiver 10 by way of an IR signal. Although an embodiment is described herein with reference to IR signals, because of the prevalent use of such signals in connection with consumer devices, it may be appreciated that any frequency range of signal is consistent with an embodiment of the present invention. Remote control 12 transmits the IR signal to IR transceiver 10, which interacts with computer 110 as will be discussed below, and the computer 110 by way of the IR transceiver 10 may transmit an IR signal to consumer device 14, wherein the consumer device 14 is controlled in some way by the IR signal transmitted by computer 10 and the IR transceiver 10. As noted above, any number of consumer devices 14 may be controlled by IR transceiver 10. In addition, any number of remote controls 12 may be used to transmit an IR signal to IR transceiver 10.

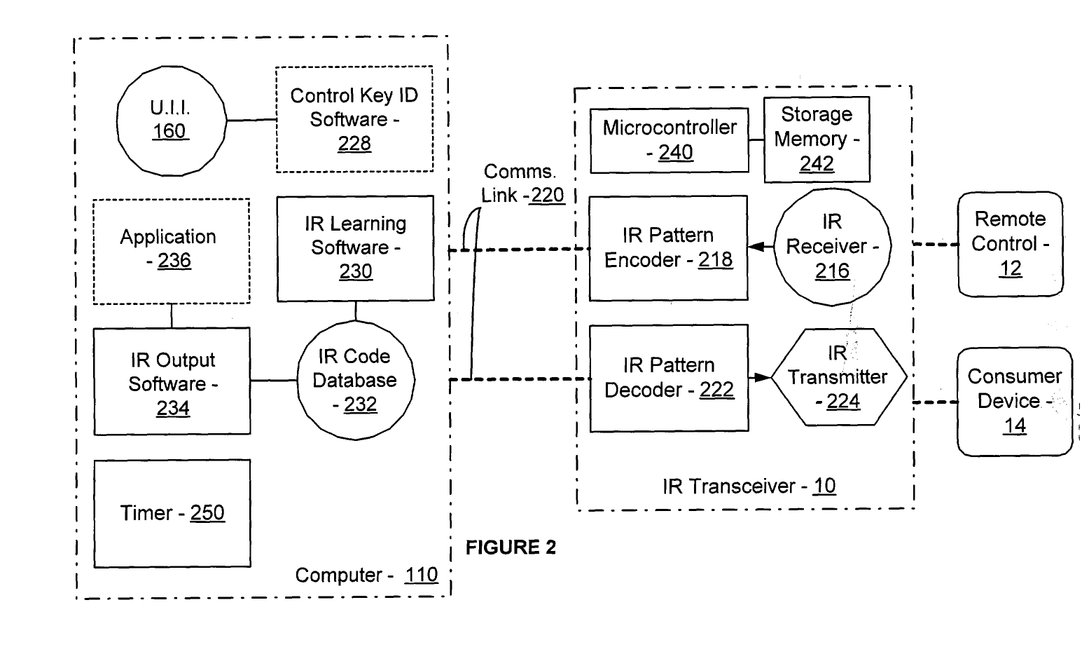

Turning now to FIG. 2, IR transceiver 10 is shown operatively connected to computer 110, remote control 12 and consumer device 14. It should be noted that one of ordinary skill in the art should be familiar with fabricating IR circuitry and IR components, and therefore such details are omitted herein for clarity. Remote control 12 may be any remote control, such as a control that is associated with consumer device 14, or a control that is designed specifically for use with computer 110, IR transceiver 10, or the like. Consumer device 14 may be any type of consumer device such as, for example, a television, stereo, DVD/CD player, VCR player, satellite receiver or the like. IR transceiver 10 receives an IR signal from remote control 12 by way of an IR receiver 216. Likewise, IR transceiver 10 transmits an IR signal to a consumer device 14 by way of an IR transmitter 224. Importantly, IR transmitter 224 may be able to transmit an IR signal to any number of consumer devices 14, either simultaneously or in rapid succession, thereby enabling IR transceiver 10 to control all of such consumer devices 14.

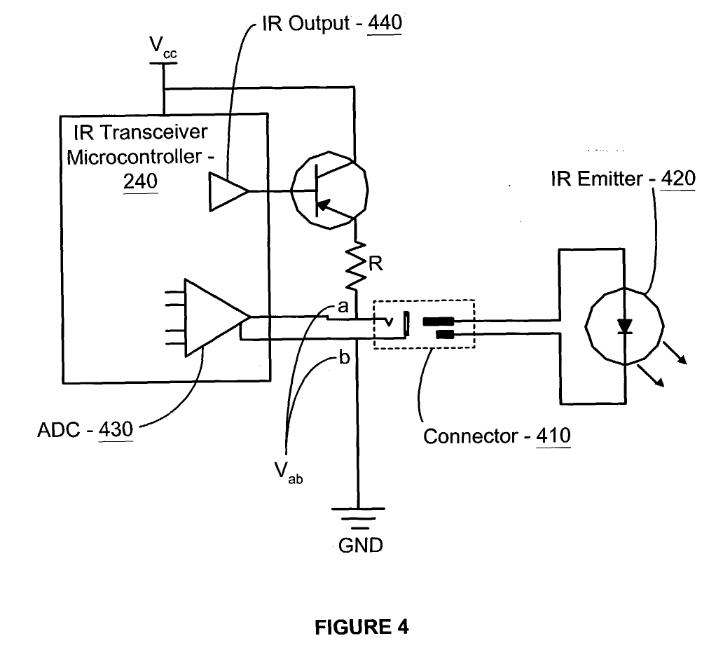

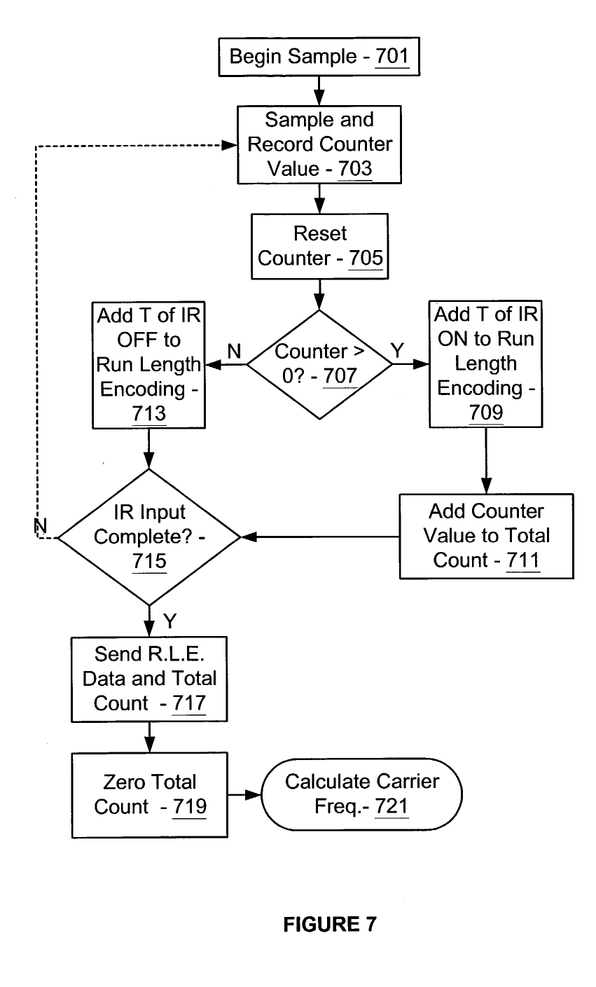

IR transceiver 10 also comprises IR pattern encoder 218 and IR pattern decoder 222. IR pattern encoder 218 receives an IR signal from IR receiver 216 and may then capture, digitize and encode the IR signal and then send the encoded IR signal to computer 110 by way of communications link 220. IR pattern encoder 218 may also estimate the carrier frequency of the IR signal by, for example, using the method of FIG. 7, below, and then may transmit that estimate to computer 110. In addition, IR pattern encoder 218 may contain circuitry for sampling the IR signal and/or performing data compression on the IR signal before sending it to computer 110. Communications link 220 operatively connects IR transceiver 10 to computer 110 and may be any type of communications connection such as, for example, a USB connection, a serial or parallel connection, an IEEE-compliant connection, a wireless connection or the like. IR pattern decoder 222 may essentially perform the opposite of many of the functions of IR pattern encoder 218 such as, for example, generating a carrier frequency for an IR signal and then sending the signal to IR transmitter 224 for transmittal to a consumer device 14. Microcontroller 240 may be any type of small-scale processor adapted to execute commands, such as commands that may be part of the method of FIG. 7, below. In addition, microcontroller 240 may also comprise the circuitry illustrated in FIG. 4, below. Operatively connected to microcontroller 240 is storage memory 242. Memory 242 may be any type of data storage device such as, for example, flash memory, address register, RAM or the like.

As may be appreciated, the componentry of IR transceiver 210 performs IR signal-specific operations so as to free computer 10 to perform functions on the IR signal. In this way, IR transceiver 10 may maintain the exact timing of IR signals that are both received and transmitted, which isolates the timing of such signals from any workload or speed issues at computer 10. For example, the timing of an IR signal transmitted to a consumer device 14 usually must be very specifically maintained, otherwise a consumer device 14 receiving such signal may not recognize the signal and therefore will not perform the desired function. Operations being performed by computer 110, whether related to the processing of IR signals or not, may cause the IR signal processing to speed up or slow down, thereby affecting the timing. Isolating the IR signal encoding and timing to the IR transceiver 10 obviates this issue, and permits the IR transceiver 10 to maintain the timing of an IR signal independently of the computer 110 workload. Likewise, the isolation of IR signal processing to the computer 10 enables the IR transceiver 10 to be small and inexpensive, because all of the signal processing components and software are part of computer 110. As will be appreciated from the discussion that follows below, the use of computer 10 to perform such signal processing provides far greater functionality with respect to the processing of such signals than would otherwise be available. In addition, leaving the processing aspects to computer 110 enables IR transceiver 10 to receive virtually any format of IR signal, because of the relatively large computing capacity of computer 110.

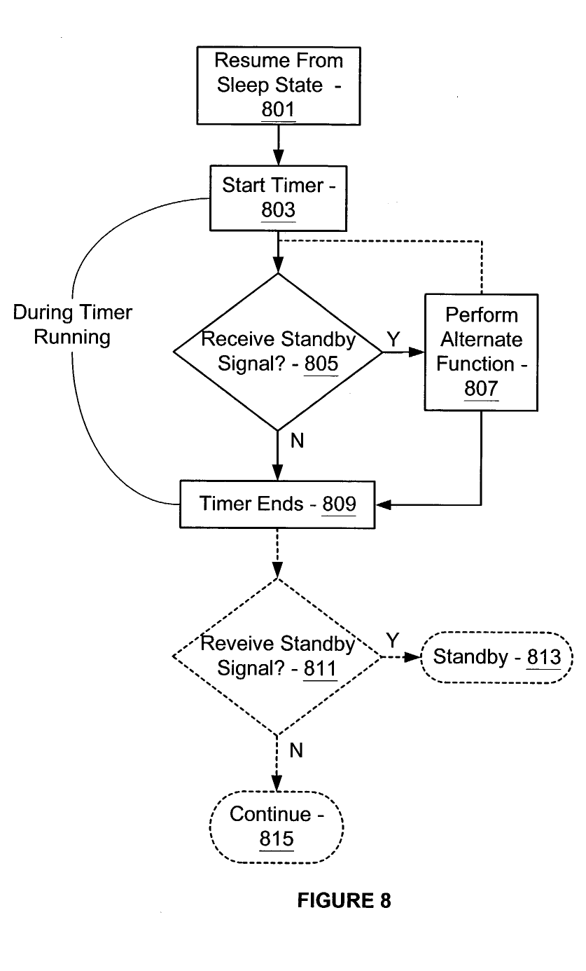

As discussed above in connection with FIG. 1, computer 110 may comprise user input interface 160. By way of such user input interface 160, a user may interact with application 236, IR learning software 230, IR output software 234 or the like. A user may also interact with control key identification software 228 by way of user input interface. Control key identification software 228 may be any type of computer program, such as a stand-alone program, an application program interface (API) or the like, that may receive an IR signal from IR transceiver 10 and receive inputs from user input interface 160. In one embodiment, control software 228 may process an IR signal to identify a remote control key associated with such IR signal, which may enable computer 10 to determine a set of IR codes associated with the control key. In addition, computer 110 may comprise timer 250. Timer 250 may be any type of timing device or program such as, for example, a programming timeout, a countdown timer, a count up timer or the like. One exemplary use of timer 250 according to one embodiment of the present invention will be discussed below in connection with FIG. 8.

IR learning software 230 may be any type of computer program that is adapted to receive an IR signal from a remote control 12 by way of IR transceiver 10 and identify the remote control code from which the signal was generated. IR learning software 230 may perform such a function in any number of ways. For example, in one embodiment IR learning software 230 may be operatively connected to an IR code database 232. IR code database 232 may be a database file, entries within a larger database or the like, of a plurality of remote control 12 codes for a consumer device 14. As may be appreciated, IR code database 232 may contain any number of remote control 12 codes, particularly in light of the large storage capacity of computer 110 when compared to a conventional remote control 12. IR learning software 230 may therefore receive an IR signal and then compare the signal to remote control 12 codes stored within the IR code database 232. Upon finding a match, IR learning software 230 may use cross-referencing information contained within IR code database 232 to identify the code set and then may generate appropriate remote control 12 codes as desired. In this way, IR learning software may enable computer 110 to “learn” the functions of a remote control 12, and then may reproduce the signals of such remote control 12 to control the desired consumer device 14 in any manner desired by a user. Importantly, IR learning software 230, upon learning the remote control 12 codes, may allow the IR output software 234 to generate the actual IR signals that would be received by such a device 14. This is in contrast to the aforementioned conventional method of learning IR signals that simply records the signal as transmitted by a remote control 12, and then later transmit the recorded IR signal.

Application 236 may be any type of computer program adapted to operate with IR signals. For example, in one embodiment application 236 is specialized software that permits customized operation of a plurality of consumer devices 14. In another embodiment, application 236 may be a network or Internet browser that permits a user to download remote control 12 code updates, specialized programs for remote control 12 and/or consumer device 14 or the like. IR output software 234 may be any type of computer program that is adapted to generate and send an IR signal to IR transceiver 10. As may be appreciated, application 236 may generate an IR signal to send to a consumer device 14 with or without a signal from remote control 12. For example, in an embodiment where application 236 is programmed to turn on a consumer device 14 at a set time, without user intervention, there will be no incoming IR signal to trigger a response from application 236. Instead, application 236 may decide to send a command to a consumer device 14, whereby the proper code is extracted from the IR code database 232 and processed by IR output software 234 and sent to IR transceiver 10. In one alternate embodiment, application 236 and IR output software 234 are the same computer program, with integrated functionality.

As may be appreciated, IR transceiver 10 may act as a bridge between computer 110, remote control 12 and a controlled consumer device 14. In one embodiment, IR transceiver 10 receives a signal from a remote control 12, sends the IR signal to computer 110, receives an IR signal from computer 110, and then transmits the signal to a consumer device 14.

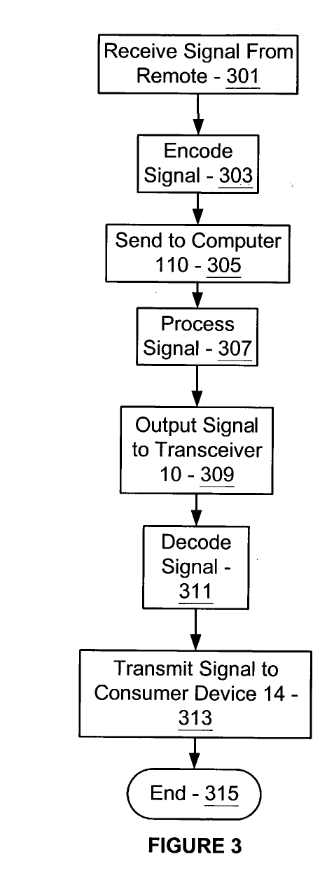

Turning now to FIG. 3, at step 301 IR transceiver 10 receives an IR signal from remote control 12. Such signal may be received by IR receiver 216 and then forwarded to IR pattern encoder 218. At step 303, IR pattern encoder 218, perhaps at the direction of microcontroller 240, encodes the IR signal. Details of one method of encoding a signal by estimating the carrier frequency in conjunction with low-frequency sampling is explained below in connection with FIG. 7. At step 305, IR transceiver 10 sends the encoded IR signal to computer 110 by way of communications link 220.

Upon receiving the encoded IR signal, computer 110 at step 307, processes the IR signal. Any number of processes may occur at step 307. For example, IR learning software 230 or other software may receive the IR signal and determine the type of consumer device 14 and/or the type of function being called for, as discussed above in connection with FIG. 2. In addition, application 236 may perform a function, generate one or more new encoded signals, respond to user input or the like with respect to the encoded IR signal. In any event, IR output software 234 may ultimately receive from the application 236 an IR signal and process the IR signal and, at step 309, output the processed IR signal to IR transceiver 10. At step 311, IR pattern decoder 222 decodes the IR signal from computer 10 and prepares it for transmission to a consumer device 14. As part of such preparation, IR pattern decoder 222 may generate an appropriate carrier frequency with which to modulate the IR signal. In one embodiment, IR pattern decoder 222 may receive a value from computer 110 indicating the proper carrier frequency to generate. At step 313, IR transmitter 224 transmits the IR signal to a consumer device 14, and at step 315, the process ends.

As may be appreciated, once the outgoing IR signal is sent to IR transceiver 10 from computer 10, steps 311, 313 and 315 may take place without further computer 110 intervention. In such a manner, therefore, IR transceiver 10 may be isolated from any processing delays that may occur in computer 10 when sending an IR signal to a consumer device 14. Thus, the proper timing of the IR signal may be generated without being affected by the workload of computer 110. At step 315, the computer 110 and IR transceiver 10 may await another incoming IR signal from a remote control 12, may shut down, enter a sleep state or the like. As may be appreciated, in such a method IR transceiver 10 may receive any type of incoming IR signal from any type of remote control 12, because none of the signal processing other than simple signal encoding for transmission of the signal to computer 10 is performed at the IR transceiver 10. Instead, such processing is performed at computer 110, which is much more capable of performing varied and robust processes with and to an IR signal. As may also be appreciated, several such methods may be taking place simultaneously, thereby enabling computer 110 and IR transceiver 10 to handle several IR signals simultaneously. For example, IR transceiver 10 may be receiving and encoding one or more IR signals, computer 110 may be processing one or more IR signals and IR transceiver 10 may also be decoding and transmitting one or more IR signals at one time.

IR Emitter Detection

An IR-emitting device, such as a remote control 12, must of course have a properly-functioning IR emitter in order to be useful. In many applications, the IR emitter is a light-emitting diode (LED). However, because IR light is outside the visible spectrum, a user cannot tell if IR light is being emitted by the device simply by looking at the device while pressing a button. Therefore, when a problem occurs involving an IR light-emitting device, a user cannot be sure whether the IR emitter is malfunctioning, the IR emitter is disconnected or whether the problem is elsewhere.

Accordingly, what is needed is a simple and inexpensive means for determining whether an IR emitter is functioning properly. Turning now to FIG. 4, circuitry fabricated in connection with microcontroller 240 of IR transceiver 10 (FIGS. 1, 2) is illustrated. The fabrication of electrical components such as those discussed in connection with FIG. 4 should be known to one skilled in the art, and is therefore not disclosed herein for clarity. In addition, although such an apparatus is disclosed in connection with IR transceiver 10, it may be appreciated that the apparatus of FIG. 4 may be employed in connection with any IR emitting device such as, for example, a remote control 12 or the like.

As seen, microcontroller 240 includes an IR output 440 that may turn on, for example, a transistor or the like to power an IR emitter 420. The IR output 440 may be a part of microcontroller 240, although the IR output 440 may also be fabricated in connection with IR transmitter 224 (FIG. 2). IR output 440, when on, creates a voltage difference V_{ab} between points a and b, and it is this voltage difference that is monitored by analog-to-digital converter (ADC) 430, as will be discussed shortly. The voltage difference V_{ab} may be created solely for the purpose of testing the status of IR emitter 420 by, for example, sending a “dummy signal,” or such voltage may be created in conjunction with an actual transmission of an IR signal. Normally, the IR emitter 420 is an LED that is plugged into the output of the microcontroller 240 and/or IR output 440 by way of a connector 410, although any type of IR emitter 420 is consistent with an embodiment of the present invention. Resistor R may have any value, which will depend upon the specific characteristics of each device 420-440 and also the voltages V_{cc}, V_{ab} used.

The status of the IR emitter 420 is monitored for three distinct situations: when the IR emitter 420 is connected and operating, when the IR emitter 420 is disconnected and when the IR emitter 420 is shorted. When IR emitter 420 is connected and operating, the current flowing through such IR emitter 420 will cause a voltage drop V_{ab} across a and b, as measured by ADC 430. The exact value of the voltage drop will depend upon the specific characteristics of each device 420-440 as well as voltage V_{cc}, but in one embodiment the voltage drop will be approximately 2V. In such a case, ADC 430, or other circuitry in operative communications with ADC 430, will monitor V_{ab} and convert the analog voltage value to a digital value. Such digital value may be analyzed by microcontroller 240 or the like to recognize that such a condition is normal and that no corrective or alerting action is necessary.

When the IR emitter 420 is disconnected, an open circuit condition will result at the connector, which will result in V_{ab} being very close to the power supply voltage, V_{cc}. It may be appreciated that a malfunction of IR emitter 420 may also cause such an open circuit condition. Thus, ADC 430 will measure such V_{ab} as being almost identical to V_{cc}. As discussed above, ADC 430 may be operatively connected to additional components such as microcontroller 240 that may be adapted to recognize such a condition as a disconnect. In one embodiment, an additional component may be a light and control circuitry for the light that, upon recognizing the disconnect illuminates such light to notify a user of the condition. Such a light may be placed on an outer housing of IR transceiver 10, thereby being visible to the user. Thus, the user will be notified of the disconnect and is able to localize the problem to the IR emitter 420. Alternately, and in another embodiment, more complex circuitry may be operatively connected to ADC 430 to perform a more complex error notification. For example, circuitry may send a message to computer 110 by way of communications link 220. Computer 110 may then access application 236 or the like to generate a message to a user by way of monitor 191, speakers 197 or the like. In one embodiment, replacement and/or repair instructions, spare part numbers and the like may be displayed to a user.

As may be appreciated, when the IR emitter 420 is shorted, for whatever reason, ADC 430 will measure V_{ab} as being essentially zero Volts. As was the case with a disconnected IR emitter 420 as discussed above, additional components (not shown) may be adapted to recognize such a condition as a short, and may notify a user accordingly. Thus, an IR emitter 420 detector for providing a cost-effective means for detecting an IR emitter 420 condition is disclosed.

Learning an IR Signal

As disclosed above in connection with FIG. 2, IR transceiver 10 may encode an incoming IR signal and estimate the signal's carrier frequency so that computer 110 will be able to know the proper carrier frequency when called upon to send an IR signal to the appropriate consumer device 14. However, as many typical IR carrier frequencies can be as high as 455 kHz or higher, sampling of such a signal would need to take place at approximately 1 MHz or higher. A sampling apparatus capable of sampling at such a rate is relatively expensive, and is therefore disfavored in low-cost IR devices. Sampling the IR signal at a slower rate will provide the envelope timing of the IR signal, but the value of the carrier frequency cannot be determined unless the sampling frequency is at least double the carrier frequency—which, as previously mentioned, requires high-speed sampling for higher-frequency carrier frequencies. Hardware counters are inexpensive and can operate at very high frequencies, but heretofore a hardware counter has not been effective in determining the carrier frequency of an incoming signal.

What is needed is a method of determining the carrier frequency of an incoming IR signal without the need to sample the IR signal at a rate that is at least twice the carrier frequency. More particularly, what is needed is a method of sampling a hardware counter that is counting the number of pulses contained in the IR signal, and performing an algorithm that determines the carrier frequency from the counted pulses and number of samples.

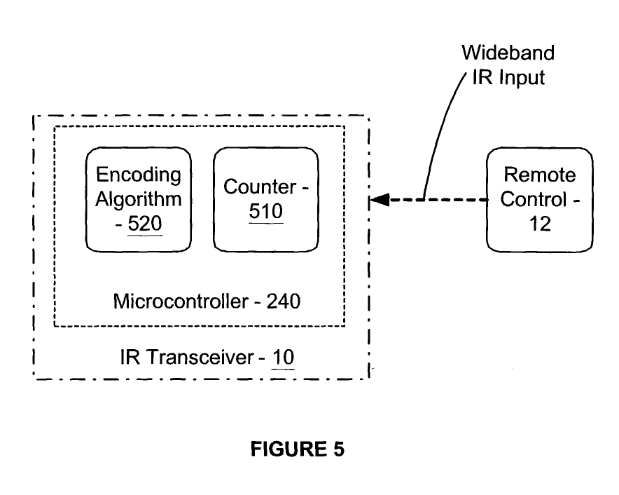

Turning now to FIG. 5, remote control 12 is shown transmitting a wideband IR signal to IR transceiver 10. Within microcontroller 240, which is as described in connection with FIG. 2, is an encoding algorithm 520 and counter 510. The encoding algorithm 520 may be any instructions that permit microcontroller 240 to carry out a carrier frequency determination such as, for example, instructions stored in memory 242 (FIG. 2). Also, microcontroller 240 may have access to memory 242 to store values during the course of the present algorithm. Counter 510 may be any type of hardware counter that is adapted to count at a rate that is high enough to count the pulses of the highest carrier frequency the IR transceiver 10 will receive from remote control 12.

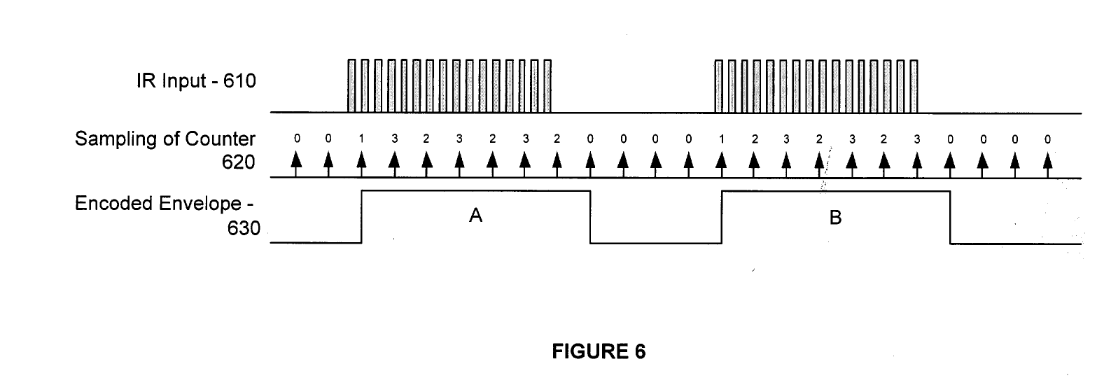

Turning now to FIG. 6, IR input 610 is the IR signal received from remote control 12. As can be seen, IR input 610 comprises two bursts of 16 pulses each. As may be appreciated, IR input 610 may comprise any number of bursts, each with any number of pulses. As may also be appreciated, the timing of pulses within each burst is constant. In other words, the carrier frequency of each burst in an IR input 610 signal from remote control 12 remains constant during a transmission. As will be appreciated during the discussion of FIG. 7, below, the constant carrier frequency of the IR input 610 is leveraged by the present algorithm to enable effective lower-speed sampling of IR input 610. As an example, the carrier frequency of IR input 610 may be 40 kHz, although any constant carrier frequency is consistent with an embodiment of the present invention.

Sampling 620 of counter 510 takes place, as can be seen, at each arrow in FIG. 6 and at a slower frequency than that of IR input 610. For example, the sampling frequency for the sampling 620 of FIG. 6 may be 16 kHz. The number atop each arrow in FIG. 6 represents the counter 510 pulse count at each sample. As may be appreciated, and as will be discussed below in connection with FIG. 7, the pulse count is zeroed during each sample so that the pulse count only contains the count of pulses that occurred between each sample 620, rather than a cumulative value. Encoded envelope 630 provides an envelope A, B of each burst as calculated by the present algorithm in a run-length encoding process or the like. The details of a run-length encoding process should be known to one skilled in the art, and therefore the details of such an encoding will not be discussed herein for clarity. As will be appreciated, each envelope A, B comprising a positive, or high, value of encoded envelope 630, is defined by a sequence of samples having a pulse count value greater than zero. Likewise, the spaces between each envelope A, B are defined by a sequence of samples having a pulse count equal to zero. In addition, it will be appreciated that the value of encoded envelope 630 remains high, thereby forming envelope A, B, for the duration of time between each pulse count. For example, for the exemplary sampling 620 frequency noted above of 16 kHz, the duration of time might be 50 μs, 62.5 μs or the like. Likewise, the spaces between each envelope A, B have a zero, or low, value at each sample having a pulse count equal to zero, and for the same duration of time afterwards.

Turning now to FIG. 7, at step 701, a process determining the carrier frequency of an IR input 610 signal begins by counting pulses of IR input 610 using counter 510. At step 703, an interrupt or other such function may take place to read the pulse count of counter 510. In addition, microcontroller 240 records the pulse count value of counter 510 and stores such value in memory 242 or the like. At step 705, the counter 510 is reset to a pulse count value of zero. At step 707, microcontroller 240 determines whether the stored value of the last pulse count is greater than zero. If so, at step 709 a certain amount of time T—such as 50 μs as in the example of FIG. 6—of IR ON is added to a run-length encoding process to create a high value for encoded envelope 630. At step 711, the stored value of the last pulse count is added to a total count value that may be stored in memory 242 or the like.

If, at step 707, microcontroller 240 determines that the stored value of the last pulse count is equal to zero, then at step 713 a certain amount of time T—such as 50 μs as in the example of FIG. 6—of IR OFF is added to a run-length encoding process to create a low value for encoded envelope 630. At step 715, microcontroller 240 makes a determination of whether the IR input 610 is complete. For step 715, microcontroller 240 may have the circuitry necessary to make such a determination, such determination may be made automatically after a certain number samples resulting in zero pulse counts, microcontroller 240 may receive input from IR receiver 216 indicating an end of IR input 610, or the like. If the IR input 610 is not complete, the process returns to step 701, where it may resume the sampling process. Thus, a plurality of samples 620 may occur.

If at step 715, the IR input 610 is determined to be completed, at step 717, the stored total pulse count, as well as the run-length encoding information used to determine the encoded envelope 630, is sent to a component such as microcontroller 240 or the like, that may calculate the carrier frequency, as will be discussed in connection with step 721, below. At step 719, the stored total pulse count is zeroed in preparation for a next IR input 610. At step 721, the run-length encoding data and total pulse count is used by microcontroller 240 or the like to determine the carrier frequency of the IR input 610. Referring for a moment to the exemplary data of FIG. 6, it may be seen that the total pulse count is 32, the number of samples having a value greater than zero is 14, and the number of bursts is 2. Microcontroller 240 uses such data to carry out the following calculation, or an equivalent thereof:

Carrier frequency=(sample frequency)*(total pulse count)/((number of samples where count>zero)−(number of bursts/2))

As may be appreciated, the numerator and first term of the denominator of such algorithm provides a rough approximation of the carrier frequency by multiplying the sample 620 frequency by the total number of pulses. The second term of the denominator refines the approximation by accounting for the offset that may be seen between IR input 610 and the encoded envelope 630. For example, encoded envelope 630 will have a high value regardless of whether a relatively low number of pulses occurred—such as is the case at the beginning or end of a burst—or whether a relatively higher number of pulses occurred—such as is the case in the middle of a burst.

Referring again for a moment to the exemplary data of FIG. 6, which in no way limits any embodiment of the present invention to any particular value, it may be seen that the above equation becomes: (16 kHz)*(32)/((14-2/2))=39,384 Hz. As may be appreciated, this resolved value is very close to the stated exemplary IR input 610 frequency of 40 kHz, and is an adequate approximation for consumer device 14 IR applications. Also, the accuracy of such a resolved value may only be limited by an amount of time—and therefore a corresponding number of measured bursts, samples having a value greater than zero and the total pulse count—over which the sampling of FIG. 7 is conducted. As may also be appreciated, this approximation was derived with a sampling frequency of 16 kHz, which was not even remotely close to twice the 40 kHz frequency of the IR input 610. Thus, transceiver 10 may transmit such approximation of the IR input 610 carrier frequency to computer 110, which may store the carrier frequency value for later use when transmitting an IR signal to a consumer device 14. For example, computer 110 may send an IR signal, along with the carrier frequency value, to transceiver 10, which will then cause IR pattern decoder 222 to generate a carrier frequency to match the value, modulate the IR signal with such carrier frequency, and then transmit the signal by way of IR transmitter 224.

Protection From User Error Upon Leaving Sleep State

Computer 110, upon a user instruction, after a designated time period of inactivity or the like, may enter into a low-power sleep state to conserve energy. While in such a sleep state computer 110 may provide only limited functionality, such as to monitor for a wake signal from a user or device. For example, a computer 110 in a sleep state may remain in such state until user presses a button on a keyboard 162, transmits an IR signal using remote control 12, or the like. In many computers 110, a standby button is provided. Such standby button may be fabricated into keyboard 191, remote control 12 or the like. Such a button typically operates in a toggle fashion, whereby pressing the button when the computer 110 is awake will cause the computer 110 to enter a sleep state, and pressing the same button when the computer 110 is in a sleep state will cause the computer 110 to wake.

Problematically, on some occasions, a user may have awakened computer 110 without realizing he or she has done so. For example, computer 110 may become awake in response to user input, but has left monitor 191 in a power conservation mode because further user interaction is not required. A user, not realizing that the computer has just awakened may press the standby button again, thinking that the computer 110 will now awake, but in actuality the user has instructed the computer 110 to resume a sleep state. In other applications, a user may press the standby button for so long that computer 110 receives the signal, wakes from the sleep state, again detects the standby signal that is still being received, and then resumes the sleep state. What is needed is a method of causing a computer 110 to wait a designated period of time after waking from a sleep state, whereby any standby or sleep signal that is received during such time period will cause an alternate action to take place, rather than resuming the sleep state.

Turning now to FIG. 8, a computer 110 resumes from a sleep state at step 801. Such resumption from a sleep state may take place according to user input, at a set time or the like. For example, a user may press a standby button as discussed above. Alternatively, a user may press a button on remote control 12 to control a consumer device 14, whereby IR transceiver 10 receives an IR signal from control 12 and transmits an encoded IR signal to computer 110 by way of communications link 220 as discussed above in connection with FIG. 3. At step 803, and in one embodiment of the present invention, a timer 250 (FIG. 250) is started. As may be appreciated, the method may be performed by the computer 110 or the IR transceiver 10, and so the timer 250 may actually be in either device. Such timer 250 may have a duration that may be adjusted by a programmer, user or the like. As may be appreciated, such timer 250 may be implemented in any manner, and any such manner is consistent with an embodiment of the present invention. For example, a timer may be implemented as a programming timeout, a countdown timer, a count up timer or the like.

At step 805, which is during the running of the timer set in step 803, a determination is made if the computer 110 has received a standby signal. If so, at step 807 an alternate function is performed. For example, if the normal process for receiving a standby signal is to pass such signal to operating system 134 or the like to cause such computer 110 to enter a sleep state, then the alternate function performed at 807 may be any other function. For example, upon receiving a standby signal at step 805, and proceeding to step 807, such computer 110 may send a “user present” signal to operating system 134, rather than the standby signal, as would normally be the case. If such a “user present” signal were sent, for example, computer 110 may turn on monitor 191 or the like, rather than resuming a sleep state. Alternately, an alternate function may be for computer 110 to ignore the received standby signal.

After step 807, the process typically continues at step 809. However, it may be appreciated that more than one standby signal may be received while the timer is counting down, in which case steps 805 and 807 may be repeated. Alternatively, such process may be adapted to perform the alternate function of step 807 only once, at which point the process proceeds directly to step 809. In such a scenario, a programmer implementing the process of FIG. 8 may, for example, assume that if more than one standby signal is received during the timer countdown, then the user actually does want the computer 110 to reenter a sleep state. Regardless, at step 809 the timer 250 ends. The timer 250, however implemented, may end on its own, may be set to zero after performing step 807 one or more times, or the like. At optional step 811, computer 110 receives a standby signal. Because the timer 250 is now ended, the computer 110 proceeds to optional step 813, where the standby signal is processed as normal. For example, the standby signal may be passed to operating system 134 or the like, whereby the operating system 134 may direct computer 110 to enter a sleep state. If no standby signal is received at step 811, computer 110 may continue normal operations at optional step 815.

Firmware Auto-Updating Method

Conventionally, updating the firmware of a device is a task that is typically difficult for a novice user to perform. In addition, a novice user either will not know to update device firmware, or will forget to do so, and therefore the device firmware quickly becomes out-of-date. As a result, the user experience with the device is adversely affected, as the out-of-date firmware causes problems with operating the device. Updating drivers for the device, however, is typically a more familiar task for the novice user because such drivers are typically installed on computer 110 and driver updates are more commonly available. Also, a driver update may be available over the Internet, such as at a manufacturer's website, and may be downloaded and installed either manually or automatically by a driver update utility or the like. In addition, in some applications the version of a device driver and the version of corresponding device firmware may need to be matched for best functionality. However, conventional methods do not provide for automatically maintaining matched versions of device driver and firmware, thereby permitting a mismatch of such versions. Accordingly, what is needed is a method of initiating and installing a device firmware update in conjunction with starting the device in the driver that does not require user intervention, and is therefore suitable for all users, including novice users.

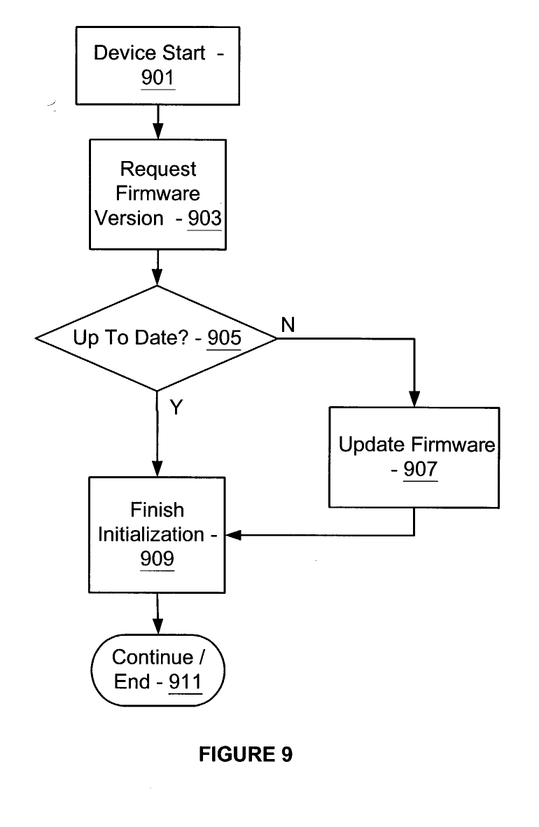

Referring now to FIG. 9, the use of a device, such as for example IR transceiver 10 or the like, is started by computer 110 at step 901. As may be appreciated, although the present method is described with reference to IR transceiver 10 herein, the present method is equally applicable to any type of peripheral device that may be operatively connected to computer 110. In starting the IR transceiver 10, the driver installed in computer 110 is initialized by computer 110 to enable communications and the like between computer 110 and IR transceiver 10. At some point during the device driver initialization, and at step 903, the device driver causes computer 110 to communicate with the IR transceiver 10 by way of communications link 220 or the like and to request from IR transceiver 10 the firmware version currently installed on IR transceiver 10. Such request may be handled by any suitable component on board IR transceiver 10, such as for example microcontroller 240 or the like.

Upon receiving the firmware version from IR transceiver 10, computer 110, at step 905, determines whether the firmware version present in IR transceiver 10 is up to date. Such a determination may be made by any means such as, for example, computer 110 sending a request for the firmware version to IR transceiver 10 by way of communications link 220, and IR transceiver 10 sending the firmware version back to computer 110 in the same manner. Typically, the driver will have a current version of the firmware contained therein, and will compare the firmware version present in IR transceiver 10 to the version of the driver. Upon detecting a match, or detecting that the firmware version on IR transceiver 10 is more recent than the firmware version contained in the driver, computer 110 proceeds to step 909, where the initialization of the driver completes. It may be appreciated that additional driver initialization steps may take place that are unrelated to the firmware present in the IR transceiver 10 prior to completion of the driver initialization at step 909.

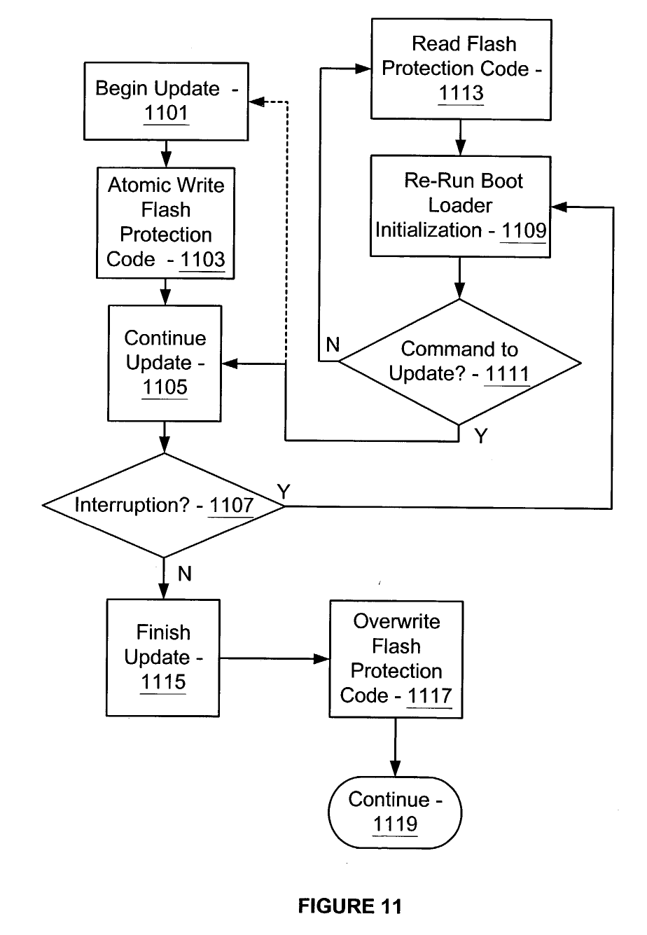

If, however, at step 905 computer 110 detects that the firmware version of IR transceiver 10 is older than the firmware version contained in the driver of computer 110, then computer 110 proceeds to step 907. At step 907, computer 110 updates the firmware of IR transceiver 10 with the firmware version that is contained in the driver. It may be appreciated that such step may take place without user intervention, or even without user knowledge. Such an update may take place in any manner such as, for example, by a method as described below in connection with FIG. 11, or any other firmware update method. Thus, the firmware of IR transceiver 10 or the like is updated as soon as an attempt to use IR transceiver 10 by computer 110 or the like is made, and does not require a user to perform any tasks related to such update. After the initialization of the driver is completed at step 909, whether or not the firmware of IR transceiver 10 is updated, computer proceeds to step 911. At step 911, computer 110, having completed the driver initialization and a firmware update, if required, may now proceed to use or communicate with IR transceiver 10.

Thus, an efficient method of updating the firmware of a device such as, for example, IR transceiver 10 is disclosed. As may be appreciated, because a newer version of the firmware may be a part of the device driver, updating the driver necessarily updates the firmware. For example, a user may periodically acquire a device driver upgrade, either manually or automatically, from a network such as the Internet, a device operatively connected to the removable or non-removable non-volatile memory interfaces 150, 140, from system memory 130, or the like. In doing so, the user will acquire a current firmware version that is included in the driver. Accordingly, the next time computer 110 attempts to use IR transceiver 10 or the like, the IR transceiver 10 firmware will be checked according to step 905 of FIG. 9 for the most recent version of the firmware, and if the most recent version is not present, the update discussed in connection with step 907 will occur.

Safe Firmware Update

When updating the firmware of a peripheral device, problems may occur that may threaten to corrupt the peripheral device,to the point that it may no longer be functional. For example, a conventional peripheral device may have a boot-loader that performs an initialization to prepare the peripheral to communicate with computer 110, and to update the firmware if such firmware is out of date. Upon completing the boot-loader initialization, the device proceeds to a memory location where the firmware is located, so as to run the firmware to operate the device. To update the firmware, a device will typically receive an update from another device such as computer 110 by way of a communications link 220 or the like. After initializing the boot-loader, the device will proceed to write the new version of the firmware to memory.

However, and significantly, problems may occur during the writing of the new firmware version. For example, a power outage may occur or the communications link 220 may become inoperative. In such a situation, when the device is to be used again, the firmware may be the new version until the point at which the problem occurred, and then the firmware may be the older version that was not yet updated. In addition, corrupted or nonsensical information may have been written to the memory when the problem occurred. When the device attempts to run the firmware in such a situation the device will, at best, run with faults, and at worst, will not run at all. Accordingly, what is needed is a method for ensuring that if a problem occurs during a firmware upgrade of a peripheral device, there is a means for reinstalling the firmware so the use of the peripheral device is not permanently impaired by the unsuccessful firmware update.

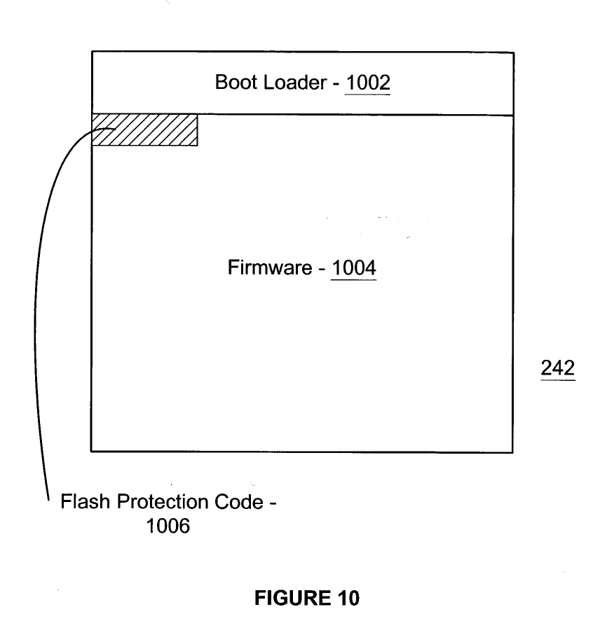

Turning now to FIG. 10, a portion of memory 242 contained within a peripheral such as IR transceiver 10 and in operative communications with microcontroller 240 (FIG. 2) of such IR transceiver 10 is shown divided into a boot-loader 1002 and firmware 1004. In one embodiment of the present invention, located in the first memory 242 location that is run after completion of a boot-loader 1002 initialization is flash protection code 1006, which will be described in greater detail in connection with FIG. 11, below. As may be appreciated, although the discussion of FIGS. 10 and 11 is provided in the context of IR transceiver 10, such method may be applied to any peripheral device while remaining consistent with an embodiment of the present invention. As may also be appreciated, FIG. 10 is provided for illustrative purposes only, and any configuration of memory 242, boot-loader 1002, firmware 1004 and flash protection code 1006 and the like is also consistent with an embodiment of the present invention.

Referring now to FIG. 11, at step 1101 an update of firmware 1004 begins, either automatically, or by the direction of computer, IR transceiver 10 or the like. The boot-loader 1002 is also initialized at this point. At step 1103, flash protection code 1006 is written to the memory 242 location that is the first portion of memory 242 containing the firmware 1004 that is read after a boot-loader 1002 initialization. Significantly, flash protection code 1006 is the first piece of data that is written to memory 242 during a firmware update, and is a small amount of information such as, for example, 8 bytes. By writing such a small amount of information, the method ensures that, even if a problem occurs very early in the firmware update process, the flash protection code 1006 will be written. For example, capacitors or other energy-storing components that may be a part of IR transceiver 10 may contain enough energy for a small amount of data, such as 8 bytes, to be written even if the power to IR transceiver 10 is shut off at the very beginning of the update. Significantly, flash protection code 1006 contains a branching instruction to re-run boot-loader 1002 initialization. After such flash protection code 1006 is written to memory 242, the update continues at step 1105.

Step 1107 represents the possible occurrence of a problem during the update process. If, at step 1107, which is really at any point during the update process, no problems occurs, then the update process will finish at step 1115 and proceeds to steps 1117 and 1119 as will be discussed below. If, however, a problem occurs, the IR transceiver 10 at some point will restart by initializing the boot-loader 1002 at step 1109. Step 1109 may occur manually by user intervention such as a restart or reboot of IR transceiver 10, computer 110 or the like, or automatically upon detecting the problem, or the like. At step 1111, which is during the boot-loader 1002 initialization process, a determination is made whether a command to restart the update process has been received. As was the case with step 1101, such command may occur automatically, or by the direction of computer, IR transceiver 10 or the like.

If such command is not received, the method proceeds to step 1113. At such step, the method begins to read the firmware 1004 beginning at the first portion of memory 242. As may be recalled, such portion of memory contains the flash protection code 1006 that was written at step 1103. As may also be recalled, flash protection code 1006 contains instructions to branch to boot-loader 1002 initialization. Thus, at step 1109, the boot-loader 1002 initialization resumes and proceeds to step 1111. As may be appreciated, the loop formed by steps 1109-1113 prevents the method from reading corrupted firmware 1004 because the flash protection code 1006 always returns the method to the boot-loader 1002 initialization before the method can attempt to read the corrupted firmware 1004

If, at step 1111, such command is received, the method proceeds to step 1105 to continue to update the firmware 1004. Alternately, the method may proceed to step 1101 to restart the entire process, including the writing of the flash protection code 1006 at step 1103. As may be appreciated, overwriting a flash protection code 1006 with another flash protection code 1006 will yield an equivalent branching result to that described above in connection with step 1113.

At step 1115, the update process is completed, and at step 1117, the flash protection code 1006 is overwritten. The overwrite of flash protection code 1006 may contain more firmware 1004 code or the like. By overwriting the flash protection code 1006, IR transceiver 10 will now be able to run the updated firmware because the instruction to branch to the boot-loader 1002 initialization is no longer present. Finally, at step 1119, the firmware 1004 update process ends. Therefore, a safe firmware update process for a computer 110 peripheral device, such as IR transceiver 10 or the like is provided.

As may be appreciated, in the preceding discussion specific computer and device programming that may be performed in connection with an embodiment of the present invention is not disclosed, but should be apparent to those skilled in the art. Thus, a format independent IR transceiver 10 is disclosed. While the present invention has been described in connection with the preferred embodiments of the various figures, it is to be understood that other similar embodiments may be used or modifications and additions may be made to the described embodiment for performing the same function of the present invention without deviating therefrom. For example, while many of the examples contained herein are explained in the context of an IR transceiver 10, many aspects of the present invention are equally applicable to any computer peripheral device. As an additional example, one skilled in the art will recognize that the present invention as described in the present application may apply to any computing device or environment, whether wired or wireless, and may be applied to any number of such computing devices connected via a communications network, and interacting across the network. Therefore, the present invention should not be limited to any single embodiment, but rather should be construed in breadth and scope in accordance with the appended claims.

What is claimed:

1. A method for interfacing a computer with a consumer device by way of a transceiver, comprising:
receiving a first signal from a remote control at the transceiver;
encoding the first signal and transmitting the encoded first signal from the transceiver to the computer by way of a communications link, the computer processing the encoded first signal;
receiving an encoded second signal at the transceiver from the computer by way of the communications link; and
decoding the encoded second signal and transmitting the decoded second signal to the consumer device.

2. The method of claim 1, wherein the first and second signal is an infrared signal.

3. The method of claim 1, wherein the communications link is a USB connection.

4. The method of claim 1, wherein the transceiver transmits a plurality of second signals to a plurality of consumer devices.

5. The method of claim 1, further comprising the computer processing the encoded first signal, comprising:
recognizing a code associated with the encoded first signal;
locating the code in a code database, wherein the code in the code database has at least one associated encoded signal; and
generating the encoded second signal according to the at least one associated encoded signal.

6. The method of claim 1, further comprising the computer processing the encoded first signal, comprising:
recording an aspect of the encoded first signal;
comparing the aspect of the encoded first signal with entries in a code database, wherein the entries in the code database have aspects of a plurality of signals;
finding a match between the aspect of the encoded first signal and an aspect of one of the plurality of signals contained in one or more entries in the code database; and
generating the encoded second signal according to the aspect of one of the plurality of signals contained in one or more entries in the code database.

7. The method of claim 1, further comprising the computer processing the encoded first signal, comprising:
analyzing the encoded first signal to determine a predetermined function; and
generating at least one encoded signal adapted to perform the predetermined function.

8. The method of claim 1, further comprising the computer processing the encoded first signal, comprising receiving user input by way of a user interface and generating the encoded second signal according to the user input.

9. The method of claim 1, further comprising:
operating an infrared emitter based on a reference voltage;
monitoring a voltage difference across a connector to which the infrared emitter is connected;
determining whether the voltage difference across the connector is approximately the reference voltage and, if so, performing a first predetermined action; and
determining whether the voltage difference across the connector is approximately zero volts and, if so, performing a second predetermined action.

10. The method of claim 1, wherein said encoding step comprises:
counting pulses contained in at least one burst of a received signal using a counter, wherein the pulses of the received signal have a constant carrier frequency;
sampling the counter at a slower rate than a rate at which the counter is counting, to determine whether the pulse count is zero;
recording a total number of pulses, a total number of non-zero pulses and a total number of bursts; and
determining whether the received signal has ended and, if so, determining an approximate value of the carrier frequency by way of the sampling rate, total pulse count, total number of non-zero pulses and the total number of bursts.

11. The method of claim 1, further comprising waking the computer from a sleep state; setting a predetermined period of time; determining whether a standby signal has been received by the computer during the predetermined period of time and, if so, performing a predetermined function other than placing the computer in a sleep state.

12. The method of claim 1, further comprising:
initializing a transceiver driver on the computer, the transceiver driver including a copy of firmware for the transceiver with a first version indicator;
requesting a firmware version with a second version indicator from the transceiver as part of the initialization;
comparing the first and second firmware version indicators; and
determining from the comparison of the first and second version indicators whether the firmware version from the transceiver is older than the firmware of the transceiver driver and, if so, updating the firmware from the transceiver with the firmware of the transceiver driver.

13. The method of claim 1, for updating the firmware of the transceiver, the method comprising:
writing a flash protection code to a memory location of the firmware immediately following the boot-loader initialization in the transceiver, wherein the flash protection code has instructions to branch to the transceiver boot-loader initialization;
writing the update of the firmware to the transceiver;
determining whether an interruption of the firmware update has occurred and, if so:
running the transceiver boot-loader initialization;
re-running the transceiver boot-loader initialization according to the flash protection code until a command to update the firmware is received and, upon receiving the command, restarting the update of the firmware version of the transceiver;
completing the update of the firmware version of the transceiver; and
overwriting the flash protection code.

14. The method of claim 13, further comprising receiving a firmware update from the computer by way of the communications link.

15. A method of detecting an infrared emitter, comprising:
operating an infrared emitter based on a reference voltage;
monitoring a voltage difference across a connector to which the infrared emitter is connected with an analog to digital converter;
determining whether the monitored voltage difference across the connector is approximately the reference voltage and, if so, performing a first predetermined action; and
determining whether the monitored voltage difference across the connector is approximately zero volts and, if so, performing a second predetermined action.

16. The method of claim 15, wherein the first and second predetermined actions are the same action.

17. The method of claim 15, wherein the first predetermined action is generating a notification corresponding to an open circuit condition.

18. The method of claim 15, wherein the second predetermined action is generating a notification corresponding to a short circuit condition

19. The method of claim 15, wherein the infrared emitter is a light-emitting diode.

20. The method of claim 15, wherein the method is performed by an infrared transceiver.

21. The method of claim 15, wherein the method is performed by a remote control.

22. A method of estimating a carrier frequency of a signal, the method comprising:
counting pulses contained in at least one burst of a received signal using a counter, wherein the pulses of the received signal have a constant carrier frequency;
sampling the counter at a slower rate than a rate at which the counter is counting, to determine whether the pulse count is zero;
recording a total number of pulses, a total number of non-zero pulses and a total number of bursts; and
determining whether the received signal has ended and, if so, calculating an approximate value of the carrier frequency by way of the sampling rate, total pulse count, total number of non-zero pulses and the total number of bursts.

23. The method of claim 22, wherein said calculating step takes place according to the equation: carrier frequency=(sampling rate)*(total pulse count)/((total number of non-zero pulses)−(total number of bursts/2)).

24. The method of claim 22, wherein said transmitting step further comprises transmitting the determined approximate carrier frequency to the computer by way of the communications link.

25. A method of preventing an unintended placement of a computer into a sleep state, comprising:
waking a computer from a sleep state;
setting a predetermined period of time during which the computer will not be placed into a sleep state in response to a standby signal; and
determining whether a standby signal has been received by the computer during the predetermined period of time and, if so, performing a predetermined function other than placing the computer in a sleep state.

26. The method of claim 25, wherein the predetermined function is sending a user present signal to an operating system of the computer.

27. The method of claim 25, wherein the predetermined function is ignoring the standby signal.

28. The method of claim 25, further comprising determining whether the standby signal has been received by the computer outside the predetermined period of time and, if so, sending the standby signal to an operating system of the computer.

29. A method of updating peripheral device firmware using a device driver, the method comprising:
initializing a peripheral device driver on a computer, the peripheral device driver including a copy of firmware for the peripheral device with a first version indicator;
requesting a firmware version with a second version indicator from the peripheral device as part of the initialization;
comparing the first and second version indicators; and
determining from the comparison of the first and second version indicators whether the firmware version from the peripheral device is older than the firmware of the peripheral device driver and, if so, updating the firmware version from the peripheral device with the firmware of the peripheral device driver.

30. A method for safely updating firmware of a peripheral device, the method comprising:
writing a flash protection code to a memory location of the firmware immediately following the boot-loader initialization in the peripheral device, wherein the flash protection code has instructions to branch to the peripheral device boot-loader initialization;
writing the update of the firmware to the peripheral device;
determining whether an interruption of the firmware update has occurred and, if so:
running the peripheral device boot-loader initialization;
re-running the peripheral device boot-loader initialization according to the flash protection code until a command to update the firmware is received and, upon receiving the command, restarting the update of the firmware version of the peripheral device;
completing the update of the firmware version of the peripheral device; and
overwriting the flash protection code.

31. The method of claim 30, wherein the command to update the firmware is sent by a computer.

32. The method of claim 31, further comprising receiving the firmware update from the computer by way of a communications link.
